(19) United States
(12) Patent Application Publication
(10) Pub. No.: US 2021/0355014 A1
(43) Pub. Date: Nov. 18, 2021

(54) Process and device for treating wastewater or sludge

(71) Applicant: Andreas Dünnebeil, Teltow (DE)

(72) Inventor: Andreas Dünnebeil, Teltow (DE)

(21) Appl. No.: 17/307,993

(22) Filed: May 4, 2021

(30) Foreign Application Priority Data
May 15, 2020 (DE) 10 2020 206 172.6

(51) Int. Cl. C02F 11/145; C02F 11/143; C02F 1/20; C02F 1/52; C02F 1/68

(52) U.S. Cl. CPC C02F 11/145; C02F 11/143; C02F 1/20; C02F 2101/105; C02F 1/686; C02F 1/687; C02F 1/5245

(57) ABSTRACT

The invention relates to a process for treating wastewater or sludge, in which a wastewater or sludge stream (2) is conveyed through a first mixing unit (15), wherein a base/alkaline solution (17) or a phosphate-fixing compound/liquid containing a phosphate-fixing compound (17) is metered or mixed into the first mixing unit (15).

The invention further relates to a device (100) for treating a wastewater or sludge stream (2), especially for carrying out the aforementioned process.

This United States utility patent application claims priority on and the benefit of German (DE) patent application number 10 2020 206 172.6, filed May 15, 2020, the entire contents of which are hereby incorporated herein by reference.

### FIELD OF APPLICATION AND PRIOR ART

The invention relates to a process for treating wastewater or sludge and to a device for treating wastewater or sludge.

The treatment of sludges, for example in a wastewater treatment plant, is done in many steps. A major step in the treatment of sludges is the dewatering of the often digested sewage sludge. Said step is essential for the reduction of the water fraction in the sludge. The goal of dewatering is to achieve a highest possible solids content with simultaneously high efficiency of solids separation. Dewatering is usually supported by the addition of polymeric flocculants. Appropriate flocculants establish bonds between individual sludge constituents, thereby optimizing the formation of a floc structure. As a result of an optimized floc structure, free water can drain off more efficiently between sludge bacteria.

Fundamentally, a distinction is made between various water types in the dewatering operation for sewage sludge. The so-called free water is water which is situated between individual sludge particles without forming a bond with the sludge particles. Only this water can be removed in the dewatering operation. A further water fraction is the so-called intermediate water. The intermediate water is adsorbed on the surface of the individual sludge particles, especially by physisorption and/or chemisorption. A further water fraction is situated within the sludge particles. Said water fraction is also referred to as so-called cell water. In contrast to the aforementioned free water, the intermediate water and the cell water cannot be removed when dewatering sewage sludge.

One problem in wastewater or sludge treatment is the deposition of sparingly soluble phosphate compounds, especially in the form of magnesium ammonium phosphate (MAP, struvite), in subsequent plant components. Because of this and because of relevant legal requirements, processes of the type in question aim at the removal of phosphates from wastewater or sewage sludge. To this end, soluble phosphates contained in the wastewater or sewage sludge are, for example, converted into sparingly soluble magnesium ammonium phosphate, which is subsequently removed from the wastewater or sewage sludge, for example by means of extraction or crystallization. This minimizes the phosphate content in the wastewater or sewage sludge and thus the risk of MAP deposits on plant components, which, especially as encrustations of the affected plant components, can only be removed with considerable effort. A further advantage is that a decrease in the phosphate content in the wastewater or sewage sludge can reduce the proportion of intermediate water, thereby making it possible to achieve a higher solids content when dewatering.

Relevant processes are, for example, known from EP 2 028 161 A1, DE 10 2014 019 460 A1, DE 10 2011 016 826 A1, WO 2006/028372 A1 and WO 2014/003554 A1.

However, the processes of the type in question for treating wastewater or sludge have the disadvantage that, even with their aid, the legal requirements for reduction of phosphates in the wastewater or sewage sludge can be hardly complied with and especially the removal of sparingly soluble phosphates from the wastewater or sewage sludge necessitates a not insignificant additional expenditure in terms of equipment. The phosphates are usually recovered from the remaining ash in a mono-incineration of sewage sludge.

### Object and Achievement

It is therefore an object of the invention to provide a process for treating wastewater or sludge, especially sewage sludge, preferably digested sludge, that partially or completely avoids disadvantages which occur in connection with processes of the type in question and that especially allows recovery of phosphorus, for example from sewage sludge ash. It is a further object of the invention to provide a device for treating wastewater or sludge, especially sewage sludge, preferably digested sludge, that partially or completely avoids disadvantages which occur in connection with devices of the type in question.

Aforementioned objects are achieved by a process according to independent claim 1 and by a device according to claim 18. Preferred embodiments of the process are subject matter of dependent claims 2 to 17. Preferred embodiments of the device are subject matter of dependent claims 19 to 23. The wording of all of the claims is hereby incorporated into the content of the description by express reference.

According to a first aspect, the invention provides a process for treating wastewater or sludge, especially sewage sludge, preferably digested sludge.

In the process, a wastewater or sludge stream is conveyed through a first mixing unit, wherein a base/alkaline solution or a phosphate-fixing, i.e. phosphate-binding, compound/liquid, preferably solution, containing a phosphate-fixing, i.e. phosphate-binding, compound is metered or mixed into the first mixing unit. As a result of the base/alkaline solution or the phosphate-fixing compound/liquid containing a phosphate-fixing compound being metered in or mixed in, phosphate ions contained (in a dissolved state) in the wastewater or sludge stream are advantageously bound in the form of insoluble phosphate, i.e. converted into an insoluble phosphate.

In the context of the present invention, the expression “wastewater” is to be understood to mean waters which originate from various sources and which are carried off via structural installations. In the context of the present invention, the expression “wastewater” is preferably to be understood to mean dirty water, i.e. water contaminated as a result of use, such as, for example, grey water and/or black water and/or yellow water and/or brown water.

In the context of the present invention, the term “grey water” is to be understood to mean wastewater that is slightly contaminated and free of faecal matter as per EN 12056-1, which wastewater arises, for example, during showering, bathing or hand-washing, but also comes from washing machines, and can be treated to provide service water or process water, or rain water that flows off from roofs or balconies.

In the context of the present invention, the expression “black water” is to be understood to mean domestic wastewater containing urine and/or faecal solids as per ISO 6107-7:1997.

In the context of the present invention, the expression “yellow water” is to be understood to mean urine with flush water.

In the context of the present invention, the expression “brown water” is to be understood to mean faeces, flush water and toilet paper without urine.

In the context of the present invention, the expression “sludge” is to be understood to mean a mixture of finely dispersed, predominantly very fine-grained solid and a liquid, especially aqueous liquid, preferably water, which liquid is especially of a reduced amount. When dewatering sludge, especially sewage sludge, preferably digested sludge, the proportion of water can be reduced to from 70% by weight to 80% by weight.

In the context of the present invention, the expression “sludge” is preferably to be understood to mean an organic sludge, particularly preferably sewage sludge, especially preferably digested sludge.

In the context of the present invention, the expression “organic sludge” is to be understood to mean a sludge which predominantly comprises organic constituents. Besides organic constituents, an organic sludge in the context of the present invention can comprise inorganic constituents, such as, for example, sand. Alternatively, an organic sludge in the context of the present invention can exclusively comprise organic constituents.

In the context of the present invention, the expression “sewage sludge” is to be understood to mean waste from the completed treatment of wastewater in wastewater treatment plants, which waste comprises water and also organic and mineral materials or consists of water and also organic and mineral materials. The organic and mineral materials can in turn be present in dissolved and/or in solid form. For example, a sewage sludge in a wastewater treatment plant can have a proportion of water of from 92% by weight to 99% by weight.

In the context of the present invention, the expression “digested sludge” is to be understood to mean a sewage sludge stabilized by digestion during wastewater treatment. Digested sludge is a waste product of wastewater treatment. A mixture consisting of about 92% to 99%, especially 92% to 98%, water and accordingly 1% to 8%, especially 2% to 8%, solids is concerned here. For example, about half of the solids can be inorganic and about half can be organic, for example remnants of the microorganisms of the biological wastewater treatment. Alternatively, a digested sludge in the context of the present invention can have a proportion of solids that comprises organic constituents up to an extent of 80%.

Accordingly, the expression “sludge stream” in the context of the present invention is preferably to be understood to mean an organic sludge stream, particularly preferably a sewage sludge stream, especially preferably a digested sludge stream.

In the context of the present invention, the expression “diaphragm” is to be understood to mean a device for narrowing a cross-section of a mixing unit, preferably a mixing unit which is at least sectionally tubular, especially only sectionally or continuously tubular.

In the context of the present invention, the expression “a base/alkaline solution” is to be understood to mean “a base or an alkaline solution”.

In the context of the present invention, the expression “base” is to be understood to mean a compound which, in aqueous solution, is capable of forming hydroxide ions and of thus increasing the pH of a solution.

In the context of the present invention, the expression “alkaline solution” is to be understood to mean an alkaline liquid, especially an alkaline solution. Preferably, the expression “alkaline solution” in the context of the present invention is to be understood to mean an aqueous, alkaline liquid, especially an aqueous, alkaline solution.

In the context of the present invention, the expression “a phosphate-fixing compound/liquid containing a phosphate-fixing compound” is to be understood to mean “a phosphate-fixing compound or a liquid containing a phosphate-fixing compound”.

In the context of the present invention, the expression “phosphate-fixing compound” or “phosphate-binding compound” is to be understood to mean a compound, preferably a salt, which is capable of fixing, i.e. binding, phosphate ions (of soluble phosphates) contained in the wastewater or sludge, or wastewater or sludge stream, in the form of a sparingly soluble phosphate.

In the context of the present invention, the expression “sparingly soluble phosphate” is to be understood to mean a phosphate ion-containing salt which is not soluble or only sparingly soluble in water or an aqueous liquid, especially aqueous solution. In the context of the present invention, the sparingly soluble phosphate can, for example, comprise magnesium ammonium phosphate (MAP, struvite) and/or calcium phosphate or consist of magnesium ammonium phosphate (MAP, struvite) and/or calcium phosphate.

In the context of the present invention, the expression “are/is” means “are or is”.

The present invention is distinguished by the following advantages in particular:
Metering or mixing of a base/alkaline solution into the first mixing unit increases the pH in the first mixing unit. An increase in pH has the advantage that the formation of sparingly soluble phosphates, especially of magnesium ammonium phosphate, is promoted. What is particularly advantageously achievable as a result is a comprehensive inclusion of alkaline earth metal ions, especially calcium and/or magnesium ions, originally contained in the wastewater or sludge stream in the process of forming sparingly soluble phosphates, especially magnesium ammonium phosphate.
Metering or mixing of a phosphate-fixing compound/liquid containing a phosphate-fixing compound into the first mixing unit can eliminate the disadvantage that alkaline earth metal ions, especially calcium and/or magnesium ions, originally contained in the wastewater or sludge have a limiting effect for the formation of sparingly soluble phosphates. What is achievable as a result is a comprehensive fixation of phosphate ions contained in the wastewater or sludge, in the form of sparingly soluble phosphates, especially in the form of magnesium ammonium phosphate. The metering or mixing of a phosphate-fixing compound/liquid containing a phosphate-fixing compound into the first mixing unit may, for example, suffice when the wastewater to be treated or the sludge to be treated already has an alkaline pH, especially a pH of from 8 to 8.5.
A further advantage of the invention is that good mixing of the wastewater or sludge stream with the base/alkaline solution or the phosphate-fixing compound/liquid containing a phosphate-fixing compound is achievable by means of the first mixing chamber.

In one embodiment of the invention, the wastewater or sludge stream is conveyed through a mixing chamber of the first mixing unit via an opening of a diaphragm of the first mixing unit, i.e. through an opening of a diaphragm of the first mixing unit. Preferably, the mixing chamber of the first mixing unit is arranged after, especially immediately after, the diaphragm and/or the opening of the diaphragm of the first mixing unit in the conveying direction of the wastewater or sludge stream. What is achievable by a first mixing unit designed in this way is particularly good mixing of the wastewater or sludge stream with the base/alkaline solution or the phosphate-fixing compound/liquid containing a phosphate-fixing compound. The diaphragm or, more precisely, the opening of the diaphragm of the first mixing unit advantageously generates a so-called free jet in the mixing chamber of the first mixing unit. Said free jet arises because the wastewater or sludge stream issuing from the diaphragm opening and the wastewater or sludge stream already situated in the mixing chamber have different velocities. What arises therebetween is a shear layer from which a free jet develops. Around the free jet, there is establishment of a secondary flow which ensures intensive mixing in the mixing chamber of the wastewater or sludge stream with the metered-in or mixed-in base/alkaline solution or the phosphate-fixing compound/liquid containing a phosphate-fixing compound.

In a further embodiment of the invention, sparingly soluble phosphate, especially magnesium ammonium phosphate, is not removed from the wastewater or sludge stream. In particular, the wastewater or sludge stream can be conveyed into a dewatering unit, especially into a dewatering unit downstream of the first mixing unit, without separation or removal of a sparingly soluble phosphate, especially magnesium ammonium phosphate. The present invention is based especially on the surprising finding that it is not necessary to separate off or remove sparingly soluble phosphate, especially magnesium ammonium phosphate, from wastewater or a sludge in order to achieve high proportions of solids in subsequent dewatering of the wastewater or sludge. This advantageously dispenses with the complicated process measures for separating off sparingly soluble phosphates, especially by extraction and/or crystallization, that are practised in conventional processes. The result is a significantly simplified and especially optimized process for treating wastewater or sludge, especially without this increasing the proportion of intermediate water. Furthermore, it has advantageously been found that the proportion of intermediate water can be successfully reduced even when sparingly soluble phosphate remains in the wastewater or sewage sludge. The reduced proportion of intermediate water leads in turn to a reduction in the proportion of water in the dewatered sludge. This can, for example, distinctly reduce an energy input required for subsequent drying. Furthermore, freight and disposal costs of correspondingly treated sludges can be noticeably lowered.

Alternatively, sparingly soluble phosphate, especially magnesium ammonium phosphate, can be removed from the wastewater or sludge stream, for example by means of extraction or crystallization. If necessary, the sparingly soluble phosphate, especially magnesium ammonium phosphate, is preferably removed from the wastewater or sludge stream by an extraction unit for extraction of sparingly soluble phosphate, especially magnesium ammonium phosphate, that is downstream of the first mixing unit and/or by a crystallization unit for crystallization of sparingly soluble phosphate, especially magnesium ammonium phosphate, that is downstream of the first mixing unit and/or by a separator unit for separation of sparingly soluble phosphate, especially magnesium ammonium phosphate, that is downstream of the first mixing unit.

In a further embodiment of the invention, the first mixing unit is at least sectionally tubular, especially only sectionally or completely tubular. In principle, the first mixing unit can have a polygonal, for example triangular, quadrangular, pentagonal or hexagonal, or star-shaped or flower-shaped cross-section. A star-shaped or flower-shaped cross-section can advantageously increase the separation-edge length. Preferably, the first mixing unit has a cornerless, especially elliptical, oval or circular, cross-section. A circular cross-section is particularly preferred. Preferably, the first mixing unit is designed as a so-called pipe mixer.

In a further embodiment of the invention, the wastewater or sludge stream is conveyed at a volume flow rate of from 1 m³/h to 150 m³/h, especially 3 m³/h to 50 m³/h, preferably 5 m³/h to 30 m³/h, through the first mixing unit. Owing to the volume flow rates disclosed in this paragraph, it is advantageously possible to achieve high energy densities in the first mixing unit, especially in the mixing chamber of the first mixing unit, the result being that it is possible to additionally improve mixing of the wastewater or sludge stream with the metered-in or mixed-in base/alkaline solution or the metered-in or mixed-in phosphate-fixing compound/liquid containing a phosphate-fixing compound.

In a further embodiment of the invention, the opening of the diaphragm of the first mixing chamber has a diameter of from ≥10 mm to 500 mm, especially 25 mm to 250 mm, preferably 50 mm to 150 mm. Owing to the diaphragm opening diameters disclosed in this paragraph, it is (likewise) advantageously possible to generate high energy densities in the first mixing unit, especially in the mixing chamber of the first mixing unit, the result being that it is (likewise) possible to additionally optimize mixing of the wastewater or sludge stream with the metered-in or mixed-in base/alkaline solution or the metered-in or mixed-in phosphate-fixing compound/liquid containing a phosphate-fixing compound.

In a further embodiment of the invention, the first mixing unit has a mixing chamber volume of from 11 to 250 l, especially 21 to 110 l, preferably 51 to 45 l. Owing to the mixing chamber volumes disclosed in this paragraph, it is (likewise) advantageously possible to create high energy densities in the first mixing unit, especially in the mixing chamber of the first mixing unit, the result being that it is (likewise) possible to additionally optimize mixing of the wastewater or sludge stream with the metered-in or mixed-in base/alkaline solution or the metered-in or mixed-in phosphate-fixing compound/liquid containing a phosphate-fixing compound.

Preferably, an energy density of ≥5 kW/m³, especially of from 5 kW/m³ to 10 kW/m³, is created or generated in the first mixing unit, especially in the mixing chamber of the first mixing unit, especially by selection of an appropriate volume flow rate for the wastewater or sludge stream and/or of an appropriate diameter for the opening of the diaphragm and/or of an appropriate mixing chamber volume for the mixing chamber.

Further preferably, sparingly soluble phosphate is not removed from the wastewater or sludge stream in the first mixing unit, especially in the mixing chamber of the first mixing unit.

In a further embodiment of the invention, the first mixing unit, especially the mixing chamber of the first mixing unit, has a coating, specifically an internal coating, which prevents deposition, especially permanent deposition, of sparingly soluble phosphate, especially of magnesium ammonium phosphate, in the first mixing unit, especially in the mixing chamber of the first mixing unit. The coating can be, for example, an epoxy resin, especially an epoxy resin prepared from bisphenol A epichlorohydrin resins, especially with an average molecular weight of ≤700, bisphenol F epichlorohydrin resins, especially with an average molecular weight of ≤700, and oxirane and also mono[(C₁₂₋₁₄-alkyloxy)methyl] derivatives. Such an epoxy resin is, for example, commercially available under the name Sikafloor®-220 W Conductive. As a result, the formation of difficult-to-remove encrustations composed of sparingly soluble phosphate, especially magnesium ammonium phosphate, can be particularly advantageously avoided.

In a further embodiment of the invention, the base/alkaline solution or the phosphate-fixing compound/liquid containing a phosphate-fixing compound is metered or mixed into the first mixing unit, especially into the mixing chamber of the first mixing unit, via an annular gap or via a number of annularly arranged openings. In the context of the present invention, the expression “number of annularly arranged openings” is to be understood to mean 1 to 24, preferably 4 to 12, annularly arranged openings. Preferably, the annular gap or the number of annularly arranged openings is arranged coaxially in relation to the diaphragm and/or the opening of the diaphragm of the first mixing unit. What is advantageously achievable as a result is particularly effective metering or mixing of the base/alkaline solution or the phosphate-fixing compound/liquid containing a phosphate-fixing compound into the mixing chamber of the first mixing unit and therefore particularly effective mixing with the wastewater or sludge stream.

In a further embodiment of the invention, the pH in the first mixing unit, especially in the mixing chamber of the first mixing unit, is increased to from 7.2 to 11, preferably 8 to 8.5, as a result of the base/alkaline solution being metered in or mixed in. Such a pH range particularly advantageously promotes the formation of sparingly soluble phosphates, especially of magnesium ammonium phosphate.

In a further embodiment of the invention, the base used is sodium hydroxide and/or potassium hydroxide.

In a further embodiment of the invention, the alkaline solution used is sodium hydroxide solution, i.e. an aqueous solution of sodium hydroxide, especially 50% sodium hydroxide solution, and/or potassium hydroxide solution, i.e. an aqueous solution of potassium hydroxide, and/or calcium hydroxide solution.

In a further embodiment of the invention, the phosphate-fixing compound used is an alkaline earth metal salt, especially a calcium salt and/or magnesium salt, preferably a magnesium salt. The calcium salt can be especially selected from the group consisting of calcium chloride, calcium oxide and mixtures thereof. The magnesium salt can be especially selected from the group consisting of magnesium chloride, magnesium oxide and mixtures thereof.

As an alternative or in combination, the phosphate-fixing compound used can be especially a calcium silicate, such as, for example, calcium silicate hydrate.

As an alternative or in combination, the phosphate-fixing compound used can be an organic compound.

Particularly preferably, the phosphate-fixing compound used in the context of the present invention is a magnesium salt, especially magnesium chloride and/or magnesium oxide.

Correspondingly preferably, the liquid containing a phosphate-fixing compound is a liquid, especially solution, which contains an alkaline earth metal salt, especially a calcium salt and/or magnesium salt, preferably as disclosed in the preceding paragraphs.

In a further embodiment of the invention, the wastewater or sludge stream is furthermore conveyed through a degassing unit for degassing of the wastewater or sludge stream, i.e. for removal of gas, especially carbon dioxide and/or methane, contained in the wastewater or sludge stream, which degassing unit is upstream, especially immediately upstream, of the first mixing unit. The removal of gas, especially carbon dioxide, from the wastewater or sludge stream advantageously brings about a (slight) rise in the pH of the wastewater or sludge stream, thereby making it possible to additionally promote the formation of sparingly soluble phosphate, especially magnesium ammonium phosphate. Furthermore, this can advantageously reduce or even dispense with an addition of base/alkaline solution. The degassing unit is preferably operated under vacuum or a reduced pressure, especially under a reduced pressure in the range from −0.6 bar to −0.95 bar. The vacuum or the reduced pressure can be generated with the aid of a vacuum pump, for example liquid-ring vacuum pump. The gas, preferably carbon dioxide and methane, removed from the wastewater or sludge stream can be conveyed into an incineration unit, especially into a furnace or a cogeneration system, downstream of the degassing unit. Methane can be incinerated there to form carbon dioxide, which is substantially less damaging to the climate. A saving of CO₂ equivalents is advantageously achievable as a result. Preferably, neither a base/alkaline solution nor a phosphate-fixing compound/liquid containing a phosphate-fixing compound is metered or mixed into the degassing unit. In other words, sparingly soluble phosphate, especially magnesium ammonium phosphate, is preferably not formed in the degassing unit. Encrustations in the degassing unit can be advantageously avoided as a result.

In a further embodiment of the invention, the wastewater or sludge stream is furthermore conveyed through a second mixing unit downstream of the first mixing unit, especially through one immediately downstream of the first mixing unit.

In a further embodiment of the invention, the wastewater or sludge stream is conveyed through a mixing chamber of the second mixing unit via an opening of a diaphragm of the second mixing unit, i.e. through an opening of a diaphragm of the second mixing unit. Preferably, the mixing chamber is arranged after, especially immediately after, the diaphragm and/or the opening of the diaphragm of the second mixing unit in the conveying direction of the wastewater or sludge stream. Preferably, the second mixing unit is (likewise) designed as a pipe mixer. Further preferably, the second mixing unit (also) comprises an annular gap or a number of annularly arranged openings, especially an annular gap arranged coaxially in relation to the diaphragm and/or the opening of the diaphragm of the second mixing unit or a number of annularly arranged openings arranged coaxially in relation to the diaphragm and/or the opening of the diaphragm of the second mixing unit. In particular, the second mixing unit can (also) have a coating which prevents deposition of sparingly soluble phosphate, especially of magnesium ammonium phosphate, in the second mixing unit, especially in the mixing chamber of the second mixing unit. Especially preferably, the second mixing unit is of the same design as the first mixing unit. With regard to further features and advantages of the second mixing unit, especially with regard to any diaphragm and/or the diameter of any diaphragm and/or the mixing chamber volume of any mixing chamber and/or any annular gap or any number of annularly arranged openings and/or any coating, full reference is made to the corresponding remarks made in connection with the first mixing unit in order to avoid any repetition. The features and advantages described therein, especially with regard to any diaphragm and/or the diameter of any diaphragm and/or the mixing chamber volume of any mixing chamber and/or any annular gap or any number of annularly arranged openings and/or any coating, can also apply analogously to the second mixing unit.

In a further embodiment of the invention, a base/alkaline solution is metered or mixed into the first mixing unit, especially into the mixing chamber of the first mixing unit, and a phosphate-fixing compound/liquid, preferably solution, containing a phosphate-fixing compound is metered or mixed into the second mixing unit, especially into the mixing chamber of the second mixing unit. Preferably, the base/alkaline solution is metered or mixed into the first mixing unit, especially into the mixing chamber of the first mixing unit, via an annular gap or a number of annularly arranged openings, especially via an annular gap arranged coaxially in relation to the diaphragm and/or diaphragm opening of the first mixing unit or a number of annularly arranged openings arranged coaxially in relation to the diaphragm and/or the opening of the diaphragm of the first mixing unit, and/or the phosphate-fixing compound/liquid containing a phosphate-fixing compound is metered or mixed into the second mixing unit, especially into the mixing chamber of the second mixing unit, via an annular gap or a number of annularly arranged openings, especially via an annular gap arranged coaxially in relation to the diaphragm and/or diaphragm opening of the second mixing unit or a number of annularly arranged openings arranged coaxially in relation to the diaphragm and/or the opening of the diaphragm of the second mixing unit. In this embodiment of the invention, the advantages according to the invention stand out particularly strongly. Thus, favourable basic conditions for the formation of a sparingly soluble phosphate, especially of magnesium ammonium phosphate, can be first established in the upstream first mixing unit before the sparingly soluble phosphate, especially magnesium ammonium phosphate, is formed (to an increased extent) in the downstream second mixing unit as a result of the phosphate-fixing compound/liquid containing a phosphate-fixing compound being mixed in.

Preferably, sparingly soluble phosphate is (also) not removed from the wastewater or sludge stream in the second mixing unit, especially in the mixing chamber of the second mixing unit.

In a further embodiment of the invention, the wastewater or sludge stream is furthermore conveyed through a third mixing unit downstream of the second mixing unit, especially through one immediately downstream of the second mixing unit. What is achievable as a result is an additional optimization of the mixing of the wastewater or sludge stream, especially of constituents contained therein for formation of sparingly soluble phosphates, such as, for example, of magnesium ions, ammonium ions and phosphate ions, and therefore an additional optimization of the formation of sparingly soluble phosphates, such as magnesium ammonium phosphate in particular. Preferably, the wastewater or sludge stream is conveyed through a mixing chamber of the third mixing unit via an opening of a diaphragm of the third mixing unit, i.e. through an opening of a diaphragm of the third mixing unit. Preferably, the mixing chamber is arranged after, especially immediately after, the diaphragm and/or the opening of the diaphragm of the third mixing unit in the conveying direction of the wastewater or sludge stream. In particular, the third mixing unit can (also) be designed as a pipe mixer. Furthermore, the third mixing unit can (also) comprise an annular gap or a number of annularly arranged openings, especially an annular gap arranged coaxially in relation to the diaphragm and/or the opening of the diaphragm of the third mixing unit or a number of annularly arranged openings arranged coaxially in relation to the diaphragm and/or the opening of the diaphragm of the third mixing unit. Preferably, sparingly soluble phosphate is (also) not removed from the wastewater or sludge stream in the third mixing unit, especially in the mixing chamber of the third mixing unit. In particular, the third mixing unit can (also) have a coating which prevents deposition of sparingly soluble phosphate, especially of magnesium ammonium phosphate, in the third mixing unit, especially in the mixing chamber of the third mixing unit. Especially preferably, the third mixing unit is of the same design as the first mixing unit and/or the second mixing unit. With regard to further features and advantages of the third mixing unit, especially with regard to any diaphragm and/or the diameter of any diaphragm and/or the mixing chamber volume of any mixing chamber and/or any annular gap or any number of annularly arranged openings and/or any coating, full reference is made to the corresponding remarks made in connection with the first mixing unit in order to avoid any repetition. The features and advantages described therein, especially with regard to any diaphragm and/or the diameter of any diaphragm and/or the mixing chamber volume of any mixing chamber and/or any annular gap or any number of annularly arranged openings and/or any coating, can also apply analogously to the third mixing unit.

In a further embodiment of the invention, neither a base/alkaline solution nor a phosphate-fixing compound/liquid containing a phosphate-fixing compound is metered or mixed into the second mixing unit or into the third mixing unit, especially into the mixing chamber of the second mixing unit or into the mixing chamber of the third mixing unit.

Further preferably, the wastewater or sludge stream is conveyed with the aid of a number of pumps, i.e. with the aid of one pump or multiple pumps.

Further preferably, the pH of the wastewater or sludge stream is measured, especially with the aid of a pH measurement unit downstream of the first, second or third mixing unit. An (improved) process control is particularly advantageously achievable as a result. For example, if it turns out that the pH is too low, more base or alkaline solution can be metered or mixed into the first mixing unit, especially into the mixing chamber of the first mixing unit, in order to generate favourable starting conditions for the formation of sparingly soluble phosphates.

According to a second aspect, the invention provides a device for treating a wastewater or sludge stream, especially sewage sludge stream, preferably digested sludge stream, and/or for carrying out a process according to a first aspect of the invention.

The device comprises a first mixing unit. The mixing unit preferably comprises a diaphragm and a mixing chamber. Preferably, the mixing chamber is arranged after, especially immediately after, the diaphragm and/or an opening of the diaphragm. The device furthermore comprises a metering tank for metering or mixing of a base/alkaline solution or a phosphate-fixing compound/liquid containing a phosphate-fixing compound into the first mixing unit, especially into the mixing chamber of the first mixing unit, which metering tank is connected to the first mixing unit in a fluid-conducting manner.

Preferably, the first mixing unit comprises an annular gap or a number of annularly arranged openings for metering or mixing of the base/alkaline solution or the phosphate-fixing compound/liquid containing a phosphate-fixing compound into the first mixing unit, especially into the mixing chamber of the first mixing unit. The annular gap or the number of annularly arranged openings is preferably arranged coaxially in relation to the diaphragm and/or an opening/the opening of the diaphragm of the first mixing unit. Preferably, the first mixing unit is designed as a pipe mixer.

In a further embodiment of the invention, the device furthermore comprises a degassing unit for degassing of the wastewater or sludge stream, which degassing unit is upstream of the first mixing unit.

In a further embodiment of the invention, the device furthermore comprises a second mixing unit downstream, especially immediately downstream, of the first mixing unit. The second mixing unit preferably (likewise) comprises a diaphragm and a mixing chamber. Preferably, the mixing chamber is arranged after, especially immediately after, the diaphragm and/or an opening of the diaphragm. Preferably, the second mixing unit is (likewise) designed as a pipe mixer.

In a further embodiment of the invention, the device furthermore comprises a metering tank for metering or mixing of a phosphate-fixing compound/liquid containing a phosphate-fixing compound into the second mixing unit, especially into the mixing chamber of the second mixing unit, which metering tank is connected to the second mixing unit in a fluid-conducting manner. Preferably, the second mixing unit comprises an annular gap or a number of annularly arranged openings for metering or mixing of the phosphate-fixing compound/liquid containing a phosphate-fixing compound into the second mixing unit, especially into the mixing chamber of the second mixing unit. The annular gap or the number of annularly arranged openings is preferably arranged coaxially in relation to the diaphragm and/or an opening/the opening of the diaphragm of the second mixing unit.

Preferably, the first mixing unit and the second mixing unit are both of the same design.

In a further embodiment of the invention, the device furthermore comprises a third mixing unit downstream, especially immediately downstream, of the second mixing unit. The third mixing unit preferably (likewise) comprises a diaphragm and a mixing chamber. Preferably, the mixing chamber is arranged after, especially immediately after, the diaphragm and/or an opening of the diaphragm. In particular, the third mixing unit can (also) comprise an annular gap or a number of annularly arranged openings, especially an annular gap arranged coaxially in relation to the diaphragm and/or an opening/the opening of the diaphragm of the third mixing unit or a number of annularly arranged openings arranged coaxially in relation to the diaphragm and/or an opening/the opening of the diaphragm of the third mixing unit. Preferably, the third mixing unit is (likewise) designed as a pipe mixer.

In a further embodiment of the invention, the device does not comprise a metering tank, connected to the second mixing unit or third mixing unit in a fluid-conducting manner, for metering or mixing of a base/alkaline solution or a phosphate-fixing compound/liquid containing a phosphate-fixing compound into the second mixing unit, especially into the mixing chamber of the second mixing unit, or into the third mixing unit, especially into the mixing chamber of the third mixing unit.

With regard to further features and advantages of the device, especially with regard to the first mixing unit and/or second mixing unit and/or third mixing unit and/or degassing unit, full reference is made to the remarks made in the context of the first aspect of the invention. The features and advantages described therein especially with regard to the first mixing unit and/or second mixing unit and/or third mixing unit and/or degassing unit also apply analogously to the device according to a second aspect of the invention.

### BRIEF DESCRIPTION OF THE FIGURES

FIG. 1 shows schematically one embodiment of a process according to the invention,

FIG. 2 shows schematically one embodiment of a device according to the invention, especially for carrying out the process depicted in FIG. 1,

FIG. 3 shows schematically a further embodiment of a process according to the invention,

FIG. 4 shows schematically a further embodiment of a device according to the invention, especially for carrying out the process depicted in FIG. 3,

FIG. 5 shows schematically a further embodiment of a process according to the invention,

FIG. 6 shows schematically a further embodiment of a device according to the invention, especially for carrying out the process depicted in FIG. 5,

FIG. 7 shows schematically one embodiment of a mixing unit usable according to the invention and

FIG. 8 shows schematically one embodiment of a degassing unit usable according to the invention.

### DETAILED DESCRIPTION OF THE FIGURES

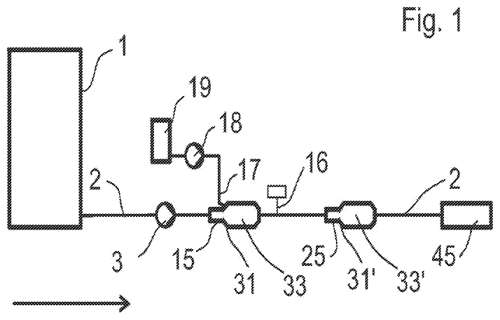

In the process schematically depicted in FIG. 1, a wastewater or sludge stream 2 is conveyed through a first mixing unit 15. The arrow depicted in FIG. 1 indicates the conveying direction of the wastewater or sludge stream 2. The wastewater or sludge stream 2 is usually taken from a storage tank 1. The storage tank 1 can be, for example, a digestion tower of a wastewater treatment plant or biogas plant. Accordingly, the wastewater or sludge stream 2 can be, for example, a digested sludge stream.

The wastewater or sludge stream 2 is preferably conveyed through the first mixing unit 15 and optionally through a second mixing unit 25 with the aid of a pump 3.

The first mixing unit 15 preferably comprises a diaphragm 31 having an opening, and a mixing chamber 33. The mixing chamber 33 is preferably arranged immediately after the diaphragm 31 and/or the opening of the diaphragm 31 in the conveying direction of the wastewater or sludge stream 2. Accordingly, the wastewater or sludge stream 2 preferably gets into the mixing chamber 33 via the opening of the diaphragm 31, i.e. through the opening of the diaphragm 31. Preferably, the diaphragm 31 has an opening diameter of from 50 mm to 150 mm. Furthermore, the mixing chamber 33 can have, for example, a volume of from 5 l to 45 l.

Furthermore, the first mixing unit 15 is preferably tubular.

A base/alkaline solution 17 or a phosphate-fixing compound/liquid containing a phosphate-fixing compound 17 is metered or mixed into the first mixing unit 15, especially into the mixing chamber 33 of the first mixing unit 15. To this end, the base/alkaline solution 17 or a phosphate-fixing compound/liquid containing a phosphate-fixing compound 17 is preferably taken from a metering tank 19. Preferably, the base/alkaline solution 17 or the phosphate-fixing compound/liquid containing a phosphate-fixing compound 17 is conveyed into the first mixing unit 15, especially into the mixing chamber 33 of the first mixing unit 15, by means of a metering pump 18.

The alkaline solution used can be, for example, sodium hydroxide solution, especially 50% sodium hydroxide solution.

As a result of the alkaline solution 17 being metered or mixed in, there is an increase in pH in the first mixing unit 15, especially in the mixing chamber 33 of the first mixing unit 15. Preferably, the pH in the first mixing unit 15, especially in the mixing chamber 33 of the first mixing unit 15, is increased to from 8 to 8.5. This advantageously promotes the formation of sparingly soluble phosphates, especially of magnesium ammonium phosphate.

The phosphate-fixing compound used can be, for example, a magnesium salt, especially magnesium chloride, magnesium oxide or a mixture thereof. Preferably, a solution containing magnesium chloride, magnesium oxide or a mixture thereof is conveyed into the first mixing unit 15, especially into the mixing chamber 33 of the first mixing unit 15.

As a result of the metering or mixing of the phosphate-fixing compound/liquid containing a phosphate-fixing compound 17 into the first mixing unit 15, especially into the mixing chamber 33 of the first mixing unit 15, it is particularly advantageously possible to achieve comprehensive binding of soluble phosphate ions contained in the wastewater or sludge stream 2, in the form of sparingly soluble phosphates, especially in the form of magnesium ammonium phosphate.

In the first mixing unit 15, what arises—in the conveying direction of the wastewater or sludge stream 2—after the diaphragm 31 and/or the diaphragm opening is a so-called free jet, around which there is establishment of a secondary flow which ensures intensive mixing of the metered-in or mixed-in base/alkaline solution 17 or the metered-in or mixed-in phosphate-fixing compound/liquid containing a phosphate-fixing compound 17 with the wastewater or sludge stream 2. Preferably, the base/alkaline solution 17 or the phosphate-fixing compound/liquid containing a phosphate-fixing compound 17 is metered or mixed into the mixing chamber 33 of the first mixing unit 15 via an annular gap or a number of annularly arranged openings, wherein the annular gap or the number of annularly arranged openings is preferably arranged coaxially in relation to the diaphragm 31 and/or diaphragm opening of the first mixing unit 15. What is achievable as a result is particularly efficient mixing of the metered-in or mixed-in base/alkaline solution 17 or the metered-in or mixed-in phosphate-fixing compound/liquid containing a phosphate-fixing compound 17 with the wastewater or sludge stream 2.

The thus treated wastewater or sludge stream 2 can furthermore be conveyed through a second mixing unit 25 downstream, especially immediately downstream, of the first mixing unit 15. The second mixing unit 25 preferably comprises a diaphragm 31′ having an opening, and a mixing chamber 33′. Preferably, the mixing chamber 33′ of the second mixing unit 25 is—in the conveying direction of the wastewater or sludge stream 2—arranged immediately after the diaphragm 31′ and/or the diaphragm opening. Accordingly, the wastewater or sludge stream 2 preferably gets into the mixing chamber 33′ via the opening of the diaphragm 31′, i.e. through the opening of the diaphragm 31′. Especially preferably, the second mixing unit 25 is also tubular. The downstream second mixing unit 25 can particularly advantageously additionally improve the mixing of the wastewater or sludge stream 2 and especially the formation of sparingly soluble phosphates, especially of magnesium ammonium phosphate.

Further preferably, neither a base/alkaline solution nor a phosphate-fixing compound/liquid containing a phosphate-fixing compound is metered or mixed into the second mixing unit 25, especially into the mixing chamber 33′ of the second mixing unit 25.

Furthermore, especially the first mixing unit 15 and/or the second mixing unit 25 can be provided with a coating on the inside, which coating prevents deposits or encrustations of sparingly soluble phosphates, especially of magnesium ammonium phosphate. The coating can be, for example, a material commercially available under the name Sikafloor®-220 W Conductive.

Furthermore, the pH of the wastewater or sludge stream 2 can be measured by means of a pH measurement unit 16 downstream of the first mixing unit 15.

Further preferably, the wastewater or sludge stream 2 is conveyed into a dewatering unit 45 downstream of the first mixing unit 15 or the second mixing unit 25 without separation or removal of sparingly soluble phosphate, especially of magnesium ammonium phosphate (MAP, struvite).

The advantages of the process depicted in FIG. 1 consist especially in low process- and equipment-related complexity, the binding of soluble phosphates (for improvement of subsequent dewatering), and in the avoidance of encrustations due to sparingly soluble phosphates, especially due to magnesium ammonium phosphate.

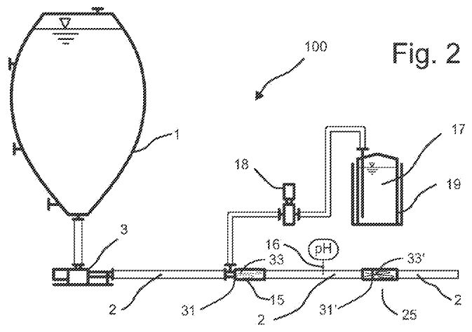

FIG. 2 shows schematically one embodiment of a device 100 according to the invention for treating a wastewater or sludge stream 2 that is especially suitable for carrying out the process schematically depicted in FIG. 1.

The device 100 comprises a first mixing unit 15. The first mixing unit 15 preferably comprises a diaphragm 31 having an opening, and a mixing chamber 33. The mixing chamber 33 is preferably arranged immediately after the diaphragm 31 and/or the opening of the diaphragm 31.

Furthermore, the device comprises a metering tank 19 for metering or mixing of a base/alkaline solution 17 or a phosphate-fixing compound/liquid containing a phosphate-fixing compound 17 into the first mixing unit 15, especially into the mixing chamber 33 of the first mixing unit 15, which metering tank 19 is connected to the first mixing unit 15 in a fluid-conducting manner. Preferably, the first mixing unit 15 comprises an annular gap or a number of annularly arranged openings for metering or mixing of the base/alkaline solution 17 or the phosphate-fixing compound/liquid containing a phosphate-fixing compound 17 into the first mixing unit 15, especially into the mixing chamber 33 of the first mixing unit 15. The annular gap or the number of annularly arranged openings is preferably arranged coaxially in relation to the diaphragm 31 and/or the opening of the diaphragm 31. Preferably, the first mixing unit 15 is tubular or designed as a pipe mixer.

Furthermore, the device can comprise a metering pump 18 for conveyance of the base/alkaline solution 17 or the phosphate-fixing compound/liquid containing a phosphate-fixing compound 17 into the first mixing unit 15, especially into the mixing chamber 33 of the first mixing unit 15, which metering pump 18 is connected between the metering tank 19 and the first mixing unit 15.

Furthermore, the device can be connected to a storage tank 1 for wastewater or sludge, especially sewage sludge, preferably digested sludge, in a fluid-conducting manner. The storage tank 1 can be, for example, a digestion tower of a wastewater treatment plant or of a biogas plant.

Furthermore, the device can comprise a pump 3 for conveyance of the wastewater or sludge stream 2, which pump 3 is connected between the storage tank 1 and the first mixing unit 15.

Preferably, the device furthermore comprises a second mixing unit 25 downstream, especially immediately downstream, of the first mixing unit 15. The second mixing unit 25 preferably comprises a diaphragm 31′ having an opening, and a mixing chamber 33′. Preferably, the mixing chamber 33′ of the second mixing unit 25 is arranged immediately after the diaphragm 31′ and/or the opening of the diaphragm 31′. Especially preferably, the second mixing unit 25 is also tubular or designed as a pipe mixer.

Furthermore, especially the first mixing unit 15 and/or the second mixing unit 25 can be provided with a coating on the inside, which coating prevents deposits or encrustations of sparingly soluble phosphates, especially of magnesium ammonium phosphate. The coating can be, for example, a material commercially available under the name Sikafloor®-220 W Conductive.

Furthermore, the device 100 can comprise a pH measurement unit 16 for measurement of the pH of the wastewater or sludge stream 2, which pH measurement unit 16 is downstream of the first mixing unit 15 or the second mixing unit 25.

Furthermore, the device can comprise a dewatering unit (not depicted) for dewatering of the wastewater or sludge stream 2, which dewatering unit is downstream of the first mixing unit 15 or the second mixing unit 25.

The advantages of the device depicted in FIG. 2 likewise consist especially in low process- and equipment-related complexity, the binding of soluble phosphates (for improvement of subsequent dewatering), and in the avoidance of encrustations due to sparingly soluble phosphates, especially due to magnesium ammonium phosphate.

With regard to further features and advantages of the device 100 depicted in FIG. 2, full reference is made to the figure description relating to FIG. 1. The features and advantages described there also apply analogously to the device 100 depicted in FIG. 2.

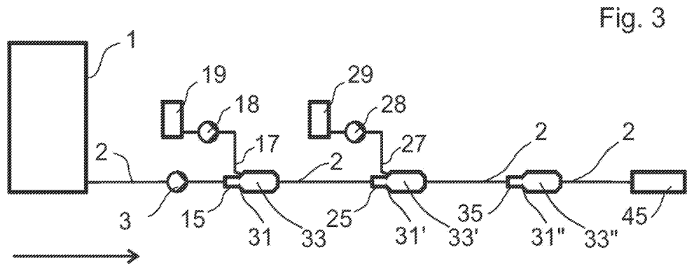

In the case of the process schematically depicted in FIG. 3, a wastewater or sludge stream 2 is conveyed through a first mixing unit 15 and through a second mixing unit 25 downstream, preferably immediately downstream, of the first mixing unit 15. The arrow depicted in FIG. 3 indicates the conveying direction of the wastewater or sludge stream 2.

The wastewater or sludge stream 2 is usually taken from a storage tank 1. The storage tank 1 can be, for example, a digestion tower of a wastewater treatment plant or biogas plant. Accordingly, the wastewater or sludge stream 2 can be, for example, a digested sludge stream.

Preferably, the wastewater or sludge stream 2 is conveyed through the first mixing unit 15, the second mixing unit 25 and optionally through a third mixing unit 35 with the aid of a pump 3.

The first mixing unit 15 preferably comprises a diaphragm 31 having an opening, and a mixing chamber 33. The mixing chamber 33 is preferably arranged immediately after the diaphragm 31 and/or the opening of the diaphragm 31 in the conveying direction of the wastewater or sludge stream 2. Accordingly, the wastewater or sludge stream 2 preferably gets into the mixing chamber 33 via the opening of the diaphragm 31, i.e. through the opening of the diaphragm 31. The first mixing unit 15 is preferably tubular.

A base/alkaline solution 17 is metered or mixed into the first mixing unit 15, especially into the mixing chamber 33 of the first mixing unit 15. To this end, the base/alkaline solution 17 is preferably taken from a metering tank 19. Preferably, the base/alkaline solution 17 is conveyed into the first mixing unit 15, especially into the mixing chamber 33 of the first mixing unit 15, by means of a metering pump 18. The alkaline solution used can be, for example, sodium hydroxide solution, especially 50% sodium hydroxide solution.

In the first mixing unit 15, what arises—in the conveying direction of the wastewater or sludge stream 2—after the diaphragm 31 and/or the diaphragm opening is a free jet, around which there is establishment of a secondary flow which ensures intensive mixing of the metered-in or mixed-in base/alkaline solution 17 with the wastewater or sludge stream 2. Preferably, the base/alkaline solution 17 is metered or mixed into the mixing chamber 33 of the first mixing unit 15 via an annular gap or a number of annularly arranged openings, wherein the annular gap or the number of annularly arranged openings is preferably arranged coaxially in relation to the diaphragm 31 and/or diaphragm opening of the first mixing unit 15. What is achievable as a result is particularly good mixing of the metered-in or mixed-in base/alkaline solution 17 with the wastewater or sludge stream 2.

The second mixing unit 25 preferably comprises a diaphragm 31′ having an opening, and a mixing chamber 33′. The mixing chamber 33′ is preferably arranged immediately after the diaphragm 31′ and/or the opening of the diaphragm 31′ in the conveying direction of the wastewater or sludge stream 2. Accordingly, the wastewater or sludge stream 2 preferably gets into the mixing chamber 33′ via the opening of the diaphragm 31′, i.e. through the opening of the diaphragm 31′. The second mixing unit 25 is preferably tubular.

A phosphate-fixing compound/liquid containing a phosphate-fixing compound 27 is metered or mixed into the second mixing unit 25, especially into the mixing chamber 33′ of the second mixing unit 25. To this end, the phosphate-fixing compound/liquid containing a phosphate-fixing compound 27 is preferably taken from a metering tank 29.

Preferably, the phosphate-fixing compound/liquid containing a phosphate-fixing compound 27 is conveyed into the second mixing unit 25, especially into the mixing chamber 33′ of the second mixing unit 25, by means of a metering pump 28. The phosphate-fixing compound used can be, for example, a magnesium salt, especially magnesium chloride, magnesium oxide or a mixture thereof. Preferably, a solution containing magnesium chloride, magnesium oxide or a mixture thereof is conveyed into the second mixing unit 25, especially into the mixing chamber 33′ of the second mixing unit 25.

In the second mixing unit 25, what arises—in the conveying direction of the wastewater or sludge stream 2—after the diaphragm 31′ and/or the diaphragm opening is likewise a free jet. Around the free jet, there is establishment of a secondary flow which ensures intensive mixing of the metered-in or mixed-in phosphate-fixing compound/liquid containing a phosphate-fixing compound 27 with the wastewater or sludge stream 2. Preferably, the phosphate-fixing compound/liquid containing a phosphate-fixing compound 27 is metered or mixed into the mixing chamber 33′ of the second mixing unit 25 via an annular gap or a number of annularly arranged openings, wherein the annular gap or the number of annularly arranged openings is preferably arranged coaxially in relation to the diaphragm 31′ and/or diaphragm opening of the second mixing unit 25. What is achievable as a result is particularly effective mixing of the metered-in or mixed-in phosphate-fixing compound/liquid containing a phosphate-fixing compound 27 with the wastewater or sludge stream 2.

The thus treated wastewater or sludge stream 2 can furthermore be conveyed through a third mixing unit 35 downstream, especially immediately downstream, of the second mixing unit 25. The third mixing unit 35 preferably comprises a diaphragm 31″ having an opening, and a mixing chamber 33″. Preferably, the mixing chamber 33″ of the third mixing unit 35 is—in the conveying direction of the wastewater or sludge stream 2—arranged immediately after the diaphragm 31″ and/or the diaphragm opening. Accordingly, the wastewater or sludge stream 2 preferably gets into the mixing chamber 33″ via the opening of the diaphragm 31″, i.e. through the opening of the diaphragm 31″. Especially preferably, the third mixing unit 35 is also tubular. The downstream third mixing unit 35 can particularly advantageously additionally optimize the mixing of the wastewater or sludge stream 2 and especially the formation of sparingly soluble phosphates, especially of magnesium ammonium phosphate.

Further preferably, neither a base/alkaline solution nor a phosphate-fixing compound/liquid containing a phosphate-fixing compound is metered or mixed into the third mixing unit 35, especially into the mixing chamber 33″ of the third mixing unit 35.

Furthermore, especially the first mixing unit 15 and/or the second mixing unit 25 and/or the third mixing unit 35 can be provided with a coating on the inside, which coating prevents deposits or encrustations of sparingly soluble phosphates, especially of magnesium ammonium phosphate. The coating can be, for example, a material commercially available under the name Sikafloor®-220 W Conductive.

Further preferably, the wastewater or sludge stream 2 is conveyed into a dewatering unit 45 downstream of the second mixing unit 25 or the third mixing unit 35 without separation or removal of sparingly soluble phosphate, especially of magnesium ammonium phosphate (MAP, struvite).

The advantages of the process depicted in FIG. 3 consist especially in low process- and equipment-related complexity, comprehensive binding of soluble phosphates (for improvement of subsequent dewatering), and in the avoidance of encrustations due to sparingly soluble phosphates, especially due to magnesium ammonium phosphate.

With regard to further features and advantages of the process depicted in FIG. 3, full reference is made to the previous figure descriptions. The features and advantages described there can also apply analogously to the process depicted in FIG. 3.

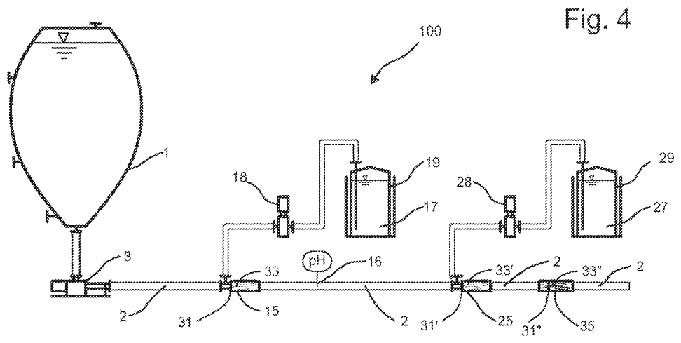

FIG. 4 shows schematically one embodiment of a device 100 according to the invention for treating a wastewater or sludge stream that is especially suitable for carrying out the process schematically depicted in FIG. 3.

The device 100 comprises a first mixing unit 15 and a second mixing unit 25 downstream, especially immediately downstream, of the first mixing unit 15.

The first mixing unit 15 and the second mixing unit 25 each preferably comprise a diaphragm 31, 31′ having an opening, and a mixing chamber 33, 33′, wherein the mixing chamber 33, 33′ is preferably arranged immediately after the diaphragm 31, 31′ and/or the opening of the diaphragm 31, 31′. Preferably, the first mixing unit 15 and the second mixing unit 25 are both tubular or designed as a pipe mixer.

Furthermore, the device 100 comprises a metering tank 19 for metering or mixing of a base/alkaline solution 17 into the first mixing unit 15, especially into the mixing chamber 33 of the first mixing unit 15, which metering tank 19 is connected to the first mixing unit 15 in a fluid-conducting manner. Preferably, the first mixing unit 15 comprises an annular gap or a number of annularly arranged openings for metering or mixing of the base/alkaline solution 17 into the first mixing unit 15, especially into the mixing chamber 33 of the first mixing unit 15. The annular gap or the number of annularly arranged openings is preferably arranged coaxially in relation to the diaphragm 31 and/or the opening of the diaphragm 31.

Furthermore, the device 100 can comprise a metering pump 18 for conveyance of the base/alkaline solution 17 into the first mixing unit 15, especially into the mixing chamber 33 of the first mixing unit 15, which metering pump 18 is connected between the metering tank 19 and the first mixing unit 15.

Furthermore, the device 100 can comprise a pH measurement unit 16 for measurement of the pH of the wastewater or sludge stream 2, which pH measurement unit 16 is downstream of the first mixing unit 15 and is especially connected between the first mixing unit 15 and the second mixing unit 25.

Furthermore, the device 100 comprises a metering tank 29 for metering or mixing of a phosphate-fixing compound/liquid containing a phosphate-fixing compound 27 into the second mixing unit 25, especially into the mixing chamber 33′ of the second mixing unit 25, which metering tank 29 is connected to the second mixing unit 25 in a fluid-conducting manner. Preferably, the second mixing unit 25 comprises an annular gap or a number of annularly arranged openings for metering or mixing of the phosphate-fixing compound/liquid containing a phosphate-fixing compound 27 into the second mixing unit 25, especially into the mixing chamber 33′ of the second mixing unit 25. The annular gap or the number of annularly arranged openings is preferably arranged coaxially in relation to the diaphragm 31′ and/or the opening of the diaphragm 31′ of the second mixing unit 25.

Furthermore, the device 100 can comprise a metering pump 28 for conveyance of the phosphate-fixing compound/liquid containing a phosphate-fixing compound 27 into the second mixing unit 25, especially into the mixing chamber 33′ of the second mixing unit 25, which metering pump 28 is connected between the metering tank 29 and the second mixing unit 25.

Furthermore, the device 100 can be connected to a storage tank 1 for wastewater or sludge, especially sewage sludge, preferably digested sludge, in a fluid-conducting manner. The storage tank 1 can be, for example, a digestion tower of a wastewater treatment plant or of a biogas plant.

Furthermore, the device 100 can comprise a pump 3 for conveyance of the wastewater or sludge stream 2, which pump 3 is connected between the storage tank 1 and the first mixing unit 15.

Furthermore, the device 100 can comprise a third mixing unit 35 downstream, especially immediately downstream, of the second mixing unit 25. The third mixing unit 35 preferably comprises a diaphragm 31″ having an opening, and a mixing chamber 33″. Preferably, the mixing chamber 33″ of the third mixing unit 35 is arranged immediately after the diaphragm 31″ and/or the opening of the diaphragm 31″. Especially preferably, the third mixing unit 35 is also tubular or designed as a pipe mixer.

Furthermore, especially the first mixing unit 15 and/or the second mixing unit 25 and/or the third mixing unit 35 can be provided with a coating on the inside, which coating prevents deposits or encrustations of sparingly soluble phosphates, especially of magnesium ammonium phosphate. The coating can be, for example, a material commercially available under the name Sikafloor®-220 W Conductive.

Furthermore, the device 100 can comprise a dewatering unit (not depicted) for dewatering of the wastewater or sludge stream 2, which dewatering unit is downstream of the second mixing unit 25 or the third mixing unit 35.

The advantages of the device 100 depicted in FIG. 4 likewise consist especially in low process- and equipment-related complexity, comprehensive binding of soluble phosphates (for improvement of subsequent dewatering), and in the avoidance of encrustations due to sparingly soluble phosphates, especially due to magnesium ammonium phosphate.

With regard to further features and advantages of the device depicted in FIG. 4, full reference is made to the previous figure descriptions. The features and advantages described there can also apply analogously to the device 100 depicted in FIG. 4.

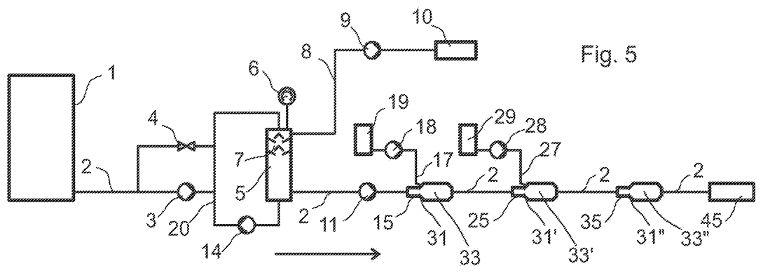

In the case of the process schematically depicted in FIG. 5, a wastewater or sludge stream 2 is conveyed through a degassing unit 5 for degassing of the wastewater or sludge stream 2, through a first mixing unit 15 downstream, especially immediately downstream, of the degassing unit 5 and through a second mixing unit 25 downstream, especially immediately downstream, of the first mixing unit 15. The arrow depicted in FIG. 5 indicates the conveying direction of the wastewater or sludge stream 2.

The wastewater or sludge stream 2 is usually taken from a suitable storage tank 1. The storage tank 1 can be, for example, a digestion tower of a wastewater treatment plant or biogas plant. Accordingly, the wastewater or sludge stream 2 can be, for example, a digested sludge stream. The wastewater or sludge stream 2 can be either conveyed into the degassing unit 5 with the aid of a pump 3 or sucked into the degassing unit 5 with the aid of a regulating valve 4 for regulation of the volume flow rate of the wastewater or sludge stream 2.

The degassing unit 5 is preferably operated under reduced pressure or vacuum, especially under a reduced pressure of from −0.6 bar to −0.95 bar. The reduced pressure or the vacuum can be adjusted using a reduced-pressure or vacuum pump 6. The reduced-pressure or vacuum pump 6 can be, for example, a liquid-ring vacuum pump. The degassing unit 5 preferably comprises fittings 7, especially a cascade of fittings 7. Foaming of the wastewater or sludge stream 2 and consequently the formation of gas bubbles is particularly advantageously achievable as a result. This supports the process to degas the wastewater or sludge stream 2 that is taking place in the degassing unit 5. A gas or gas mixture escaping from the wastewater or sludge stream 2 preferably comprises carbon dioxide and methane. The escaping gas is preferably digester gas, i.e. a gas mixture containing methane, carbon dioxide, carbon monoxide, ammonia, hydrogen sulfide and oxygen. The removal of carbon dioxide from the wastewater or sludge stream 2 causes a (slight) rise in the pH in the wastewater or sludge stream 2. This advantageously promotes the formation of sparingly soluble phosphates, especially of magnesium ammonium phosphate.

Furthermore, the wastewater or sludge stream 2 can be conveyed through the degassing unit 5 multiple times or repeatedly by means of a circulation pump 14 upstream of the degassing unit 5, especially by means of one connected between the pump 3 or regulating valve 4 and the degassing unit 5. In this connection, a ratio of wastewater or sludge stream 2 to wastewater or sludge stream 20 circulating through the degassing unit 5 can be chosen in the range from 1 to 0 to 1 to 8, preferably 1 to 3.

The gas or gas mixture which issues from the degassing unit 5 can be conveyed into an incineration unit 10, for example into a furnace or a cogeneration system, as a gas stream 8 by means of a pump 9. Issuing of methane as a gas which is particularly damaging to the climate can thereby be avoided in later dewatering of the wastewater or sludge stream 2. A high saving of CO₂ equivalents is realizable altogether.

The wastewater or sludge stream 2 which issues from the degassing unit 5 is preferably conveyed through the first mixing unit 15, the second mixing unit 25 and optionally through a third mixing unit 35 with the aid of a pump 11. The pump 11 is preferably upstream of the first mixing unit 15. In particular, the pump 11 is connected between the degassing unit 5 and the first mixing unit 15.

The first mixing unit 15 preferably comprises a diaphragm 31 having an opening, and a mixing chamber 33. The mixing chamber 33 is preferably arranged immediately after the diaphragm 31 and/or the opening of the diaphragm 31 in the conveying direction of the wastewater or sludge stream 2. Accordingly, the wastewater or sludge stream 2 preferably gets into the mixing chamber 33 via the opening of the diaphragm 31, i.e. through the opening of the diaphragm 31. The first mixing unit 15 is preferably tubular.

A base/alkaline solution 17 is metered or mixed into the first mixing unit 15, especially into the mixing chamber 33 of the first mixing unit 15. To this end, the base/alkaline solution 17 is preferably taken from a metering tank 19. Preferably, the base/alkaline solution 17 is conveyed into the first mixing unit 15, especially into the mixing chamber 33 of the first mixing unit 15, by means of a metering pump 18. The alkaline solution used can be, for example, sodium hydroxide solution, especially 50% sodium hydroxide solution.

A rise in pH caused by the degassing unit 5 can advantageously reduce the amount of base/alkaline solution.

The second mixing unit 25 preferably comprises a diaphragm 31′ having an opening, and a mixing chamber 33′. The mixing chamber 33′ is preferably arranged immediately after the diaphragm 31′ and/or the opening of the diaphragm 31′ in the conveying direction of the wastewater or sludge stream 2. Accordingly, the wastewater or sludge stream 2 preferably gets into the mixing chamber 33′ via the opening of the diaphragm 31′, i.e. through the opening of the diaphragm 31′. The second mixing unit 25 is preferably tubular.

A phosphate-fixing compound/liquid containing a phosphate-fixing compound 27 is metered or mixed into the second mixing unit 25, especially into the mixing chamber 33′ of the second mixing unit 25. To this end, the phosphate-fixing compound/liquid containing a phosphate-fixing compound 27 is preferably taken from a metering tank 29. Preferably, the phosphate-fixing compound/liquid containing a phosphate-fixing compound 27 is conveyed into the second mixing unit 25, especially into the mixing chamber 33′ of the second mixing unit 25, by means of a metering pump 28. The phosphate-fixing compound used can be, for example, a magnesium salt, especially magnesium chloride, magnesium oxide or a mixture thereof. Preferably, a solution containing magnesium chloride, magnesium oxide or a mixture thereof is conveyed into the second mixing unit 25, especially into the mixing chamber 33′ of the second mixing unit 25.

The thus treated wastewater or sludge stream 2 can furthermore be conveyed through a third mixing unit 35 downstream, especially immediately downstream, of the second mixing unit 25. The third mixing unit 35 preferably comprises a diaphragm 31″ having an opening, and a mixing chamber 33″. Preferably, the mixing chamber 33″ of the third mixing unit 35 is—in the conveying direction of the wastewater or sludge stream 2—arranged immediately after the diaphragm 31″ and/or the diaphragm opening. Accordingly, the wastewater or sludge stream 2 preferably gets into the mixing chamber 33″ via the opening of the diaphragm 31″, i.e. through the opening of the diaphragm 31″. Especially preferably, the third mixing unit 35 is also tubular. The downstream third mixing unit 35 can particularly advantageously additionally optimize the mixing of the wastewater or sludge stream 2 and especially the formation of sparingly soluble phosphates, especially of magnesium ammonium phosphate.

Further preferably, neither a base/alkaline solution nor a phosphate-fixing compound/liquid containing a phosphate-fixing compound is metered or mixed into the third mixing unit 35, especially into the mixing chamber 33″ of the third mixing unit 35.

Furthermore, especially the first mixing unit 15 and/or the second mixing unit 25 and/or the third mixing unit 35 can be provided with a coating on the inside, which coating prevents deposits or encrustations of sparingly soluble phosphates, especially of magnesium ammonium phosphate. The coating can be, for example, a material commercially available under the name Sikafloor®-220 W Conductive.

Further preferably, the wastewater or sludge stream 2 is conveyed into a dewatering unit 45 downstream of the second mixing unit 25 or the third mixing unit 35 without separation or removal of sparingly soluble phosphate, especially of magnesium ammonium phosphate (MAP, struvite).

The advantages of the process depicted in FIG. 5 consist especially in low process- and equipment-related complexity, comprehensive binding of soluble phosphates (for improvement of subsequent dewatering), in the avoidance of methane release (during subsequent dewatering), in the saving of high CO₂ equivalents, in a lower demand for base/alkaline solution, and in the avoidance of encrustations due to sparingly soluble phosphates, especially due to magnesium ammonium phosphate.

With regard to further features and advantages of the process depicted in FIG. 5, full reference is made to the previous figure descriptions, especially to the description relating to FIG. 3. The features and advantages described there, especially in the description relating to FIG. 3, can also apply analogously to the process depicted in FIG. 5.

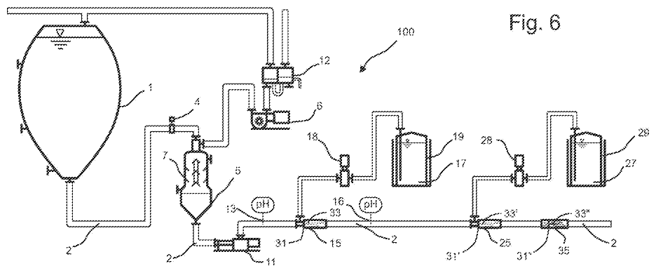

FIG. 6 shows schematically one embodiment of a device 100 according to the invention for treating a wastewater or sludge stream that is especially suitable for carrying out the process schematically depicted in FIG. 5.

The device 100 comprises a degassing unit 5 for degassing of a wastewater or sludge stream 2, a first mixing unit 15 downstream, especially immediately downstream, of the degassing unit 5, and a second mixing unit 25 downstream, especially immediately downstream, of the first mixing unit 15.

The degassing unit 5 preferably comprises fittings 7, especially a cascade of fittings 7.

The first mixing unit 15 and the second mixing unit 25 each preferably comprise a diaphragm 31, 31′ having an opening, and a mixing chamber 33, 33′, wherein the mixing chamber 33, 33′ is preferably arranged immediately after the diaphragm 31, 31′ and/or the opening of the diaphragm 31, 31′. Preferably, the first mixing unit 15 and the second mixing unit 25 are both tubular or designed as a pipe mixer.

Furthermore, the device 100 comprises a metering tank 19 for metering or mixing of a base/alkaline solution 17 into the first mixing unit 15, especially into the mixing chamber 33 of the first mixing unit 15, which metering tank 19 is connected to the first mixing unit 15 in a fluid-conducting manner. Preferably, the first mixing unit 15 comprises an annular gap or a number of annularly arranged openings for metering or mixing of the base/alkaline solution 17 into the first mixing unit 15, especially into the mixing chamber 33 of the first mixing unit 15. The annular gap or the number of annularly arranged openings is preferably arranged coaxially in relation to the diaphragm 31 and/or the opening of the diaphragm 31.

Furthermore, the device 100 can comprise a metering pump 18 for conveyance of the base/alkaline solution 17 into the first mixing unit 15, especially into the mixing chamber 33 of the first mixing unit 15, which metering pump 18 is connected between the metering tank 19 and the first mixing unit 15.

Furthermore, the device 100 comprises a metering tank 29 for metering or mixing of a phosphate-fixing compound/liquid containing a phosphate-fixing compound 27 into the second mixing unit 25, especially into the mixing chamber 33′ of the second mixing unit 25, which metering tank 29 is connected to the second mixing unit 25 in a fluid-conducting manner. Preferably, the second mixing unit 25 comprises an annular gap or a number of annularly arranged openings for metering or mixing of the phosphate-fixing compound/liquid containing a phosphate-fixing compound 27 into the second mixing unit 25, especially into the mixing chamber 33′ of the second mixing unit 25. The annular gap or the number of annularly arranged openings is preferably arranged coaxially in relation to the diaphragm 31′ and/or the opening of the diaphragm 31′.

Furthermore, the device 100 can comprise a metering pump 28 for conveyance of the phosphate-fixing compound/liquid containing a phosphate-fixing compound 27 into the second mixing unit 25, especially into the mixing chamber 33′ of the second mixing unit 25, which metering pump 28 is connected between the metering tank 29 and the second mixing unit 25.

Furthermore, the device 100 can be connected to a storage tank 1 for wastewater or sludge, especially sewage sludge, preferably digested sludge, in a fluid-conducting manner. The storage tank 1 can be, for example, a digestion tower of a wastewater treatment plant or of a biogas plant.

Furthermore, the device 100 can comprise a regulating valve 4 for regulation of the volume flow rate of the wastewater or sludge stream 2, which regulating valve 4 is upstream of the degassing unit 5 and is especially connected between the storage tank 1 and the degassing unit 5.

Alternatively, the device 100 can comprise a pump (not depicted) for conveyance of the wastewater or sludge stream 2 in the direction of the and/or through the degassing unit 5, which pump is upstream of the degassing unit 5 and is especially connected between the storage tank 1 and the degassing unit 5.

Furthermore, the device 100 can comprise a separator unit, especially a two-stage separator unit, 12. By means of the separator unit 12, water which is carried away by a gas stream leaving the degassing unit 5 can be removed from the wastewater or sludge stream 2. The separator unit 12 is expediently downstream of the degassing unit 5.

Furthermore, the device 100 can comprise a vacuum pump, especially a liquid-ring vacuum pump, 6 which is connected between the degassing unit 5 and the separator unit 12.

Furthermore, the device 100 can comprise a pump 11 for conveyance of the wastewater or sludge stream 2 through the first mixing unit 15, the second mixing unit 25 and optionally through a third mixing unit 35, which pump 11 is upstream of the first mixing unit 15 and is especially connected between the degassing unit 5 and the first mixing unit 15.

Furthermore, the device 100 can comprise a pH measurement unit 13 for measurement of the pH of the wastewater or sludge stream 2, which pH measurement unit 13 is upstream of the first mixing unit 15 and is especially connected between the degassing unit 5 and the first mixing unit 15 and is preferably connected between the pump 11 and the first mixing unit 15.

Furthermore, the device 100 can comprise a (further) pH measurement unit 16 for measurement of the pH of the wastewater or sludge stream 2, which pH measurement unit 16 is downstream of the first mixing unit 15 and is especially connected between the first mixing unit 15 and the second mixing unit 25.

Furthermore, the device 100 can comprise a third mixing unit 35 downstream, especially immediately downstream, of the second mixing unit 25. The third mixing unit 35 preferably comprises a diaphragm 31″ having an opening, and a mixing chamber 33″. Preferably, the mixing chamber 33″ of the third mixing unit 35 is arranged immediately after the diaphragm 31″ and/or the opening of the diaphragm 31″. Especially preferably, the third mixing unit 35 is also tubular or designed as a pipe mixer.

Furthermore, especially the first mixing unit 15 and/or the second mixing unit 25 and/or the third mixing unit 35 can be provided with a coating on the inside, which coating prevents deposits or encrustations of sparingly soluble phosphates, especially of magnesium ammonium phosphate. The coating can be, for example, a material commercially available under the name Sikafloor®-220 W Conductive.

Furthermore, the device 100 can comprise a dewatering unit 45 (not depicted) for dewatering of the wastewater or sludge stream 2, which dewatering unit is downstream of the second mixing unit 25 or the third mixing unit 35.

The advantages of the device depicted in FIG. 6 likewise consist especially in low process- and equipment-related complexity, comprehensive binding of soluble phosphates (for improvement of subsequent dewatering), in the avoidance of methane release (during subsequent dewatering), in the saving of high CO₂ equivalents, in a lower demand for base/alkaline solution, and in the avoidance of encrustations due to sparingly soluble phosphates, especially due to magnesium ammonium phosphate.

With regard to further features and advantages of the device depicted in FIG. 6, full reference is made to the previous figure descriptions, especially to the description relating to FIG. 4. The features and advantages described there, especially in the description relating to FIG. 4, can also apply analogously to the device depicted in FIG. 6.

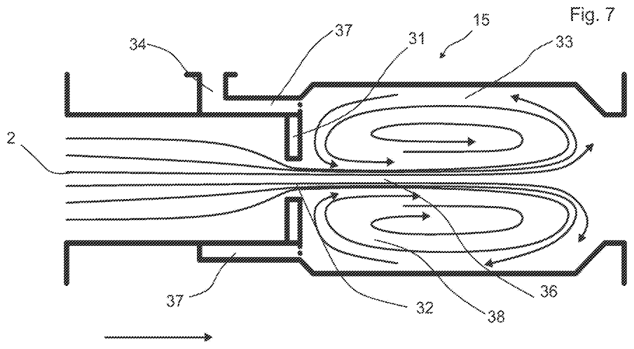

FIG. 7 shows schematically the structure of a mixing unit usable according to the invention, using the example of the first mixing unit 15. Preferably, the first mixing unit 15 is tubular and especially designed in the form of a pipe mixer. The first mixing unit 15 comprises a diaphragm 31 having a diaphragm opening 32, and a mixing chamber 33. The mixing chamber 33 is situated immediately after the diaphragm 31 and/or diaphragm opening 32, i.e. is immediately downstream of the diaphragm 31 and/or diaphragm opening 32. Furthermore, the first mixing unit 15 comprises a meter-in or mix-in opening 34. The meter-in or mix-in opening 34 opens into an annular gap 37. The annular gap 37 is arranged coaxially in relation to the diaphragm 31 and/or diaphragm opening 32.

If a wastewater or sludge stream 2 is conveyed into the first mixing unit 15, the wastewater or sludge stream 2 is contracted by the diaphragm opening 32. When the contracted wastewater or sludge stream 2 issues into the mixing chamber 33, said stream can re-expand. The result is a free jet 36, around which there is establishment of a secondary flow 38 in the mixing chamber 33. The free jet 36 and the secondary flow 38 cause a particularly intensive mixing of the wastewater or sludge stream 2 to take place. Furthermore, a base/alkaline solution or phosphate-fixing compound/liquid containing a phosphate-fixing compound that is metered or mixed in via the meter-in or mix-in opening 34 is advantageously subjected to better mixing with the wastewater or sludge stream 2 owing to the secondary flow 38. The above-described features and advantages preferably also apply analogously to the optional second mixing unit of the present invention. Apart from the meter-in or mix-in opening 34, the above-described features and advantages can also apply analogously to the optional third mixing unit of the present invention.

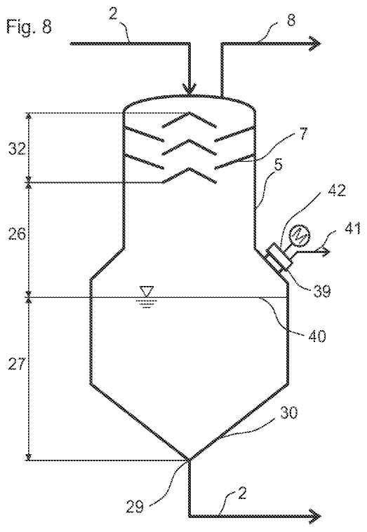

FIG. 8 shows schematically a degassing unit 5 usable in the context of the present invention. The degassing unit 5 can be subdivided into three different zones, namely into a zone 32 having fittings 7, into a defoaming zone 26 situated below the zone 32, and into a degassing zone 27 situated below the defoaming zone 26. The fittings 7 of the zone 32 are preferably designed as a cascade. In said zone, a wastewater or sludge stream 2 entering the degassing unit 5 is foamed up, which promotes the formation of gas bubbles. In the defoaming zone 26 situated therebelow, what occurs is calming of the wastewater or sludge stream 2 and consequently defoaming thereof. In the degassing zone 27 situated therebelow, what occurs is degassing of the wastewater or sludge stream 2. Furthermore, the degassing unit 5 can comprise a foam breaker 42. This can bring about additional defoaming of the wastewater or sludge stream 2, if the defoaming zone 26 is insufficient for this purpose. Gas which forms in the degassing unit 5 can be discharged as a gas stream 41 via a port 39. As an alternative or in combination, gas which forms in the degassing unit 5 can be supplied as a gas stream 8 to, for example, an incineration unit (not depicted). The degassed or largely degassed wastewater or sludge stream 2 leaves the degassing unit 5 via an outlet 29. To optimize the issue of the wastewater or sludge stream 2 from the degassing unit 5, the degassing zone 27 of the degassing unit 5 can comprise a conically shaped region 30. The total residence time of the wastewater or sludge stream 2 in the degassing unit 5 can be from 3 min to 15 min, preferably 5 min to 10 min. Preferably, the fill level 40 in the degassing unit 5 is kept constant.

I claim:

1. Process for treating wastewater or sludge, in which a wastewater or sludge stream (2) is conveyed through a first mixing unit (15), wherein a base/alkaline solution (17) or a phosphate-fixing compound/liquid containing a phosphate-fixing compound (17) is metered or mixed into the first mixing unit (15).

2. Process according to claim 1, wherein the wastewater or sludge stream (2) is conveyed through a mixing chamber (33) of the first mixing unit (15) via an opening (32) of a diaphragm (31) of the first mixing unit (15).

3. Process according to claim 1, wherein sparingly soluble phosphate is not removed from the wastewater or sludge stream (2).

4. Process according to claim 1, wherein the first mixing unit (15) is at least sectionally tubular.

5. Process according to claim 1, wherein the wastewater or sludge stream (2) is conveyed at a volume flow rate of from 1 m3/h to 150 m3/h through the first mixing unit (15).

6. Process according to claim 2, wherein the opening (32) of the diaphragm (31) has a diameter of from ≥10 mm to 500 mm and/or the mixing chamber (33) has a volume of from 1 l to 250 l.

7. Process according to claim 1, wherein the first mixing unit (15) has a coating which prevents deposition of sparingly soluble phosphate in the first mixing unit (15).

8. Process according to claim 1, wherein the base/alkaline solution (17) or the phosphate-fixing compound/liquid containing a phosphate-fixing compound (17) is metered or mixed into the first mixing unit (15) via an annular gap (37) or a number of annularly arranged openings.

9. Process according to claim 1, wherein the pH in the first mixing unit (15) is increased to from 7.2 to 11 as a result of the base/alkaline solution (17) being metered in or mixed in.

10. Process according to claim 1, wherein the base (17) used is sodium hydroxide and/or potassium hydroxide or the alkaline solution used is sodium hydroxide solution and/or potassium hydroxide solution and/or calcium hydroxide solution.

11. Process according to claim 1, wherein the phosphate-fixing compound (17, 27) used is a magnesium or calcium salt and/or a calcium silicate.

12. Process according to claim 1, wherein the wastewater or sludge stream (2) is furthermore conveyed through a degassing unit (5) for degassing of the wastewater or sludge stream (2), which degassing unit (5) is upstream of the first mixing unit (15).

13. Process according to claim 1, wherein the wastewater or sludge stream (2) is furthermore conveyed through a second mixing unit (25) downstream of the first mixing unit (15).

14. Process according to claim 13, wherein the wastewater or sludge stream (2) is conveyed through a mixing chamber (33′) of the second mixing unit (25) via an opening of the diaphragm (31′) of the second mixing unit (25).

15. Process according to claim 13, wherein a base/alkaline solution (17) is metered or mixed into the first mixing unit (15 and a phosphate-fixing compound/liquid containing a phosphate-fixing compound (27) is metered or mixed into the second mixing unit (25).

16. Process according to claim 13, wherein the wastewater or sludge stream (2) is furthermore conveyed through a third mixing unit (35) downstream of the second mixing unit (25).

17. Process according to claim 13, wherein neither a base/alkaline solution nor a phosphate-fixing compound/liquid containing a phosphate-fixing compound is metered or mixed into the second mixing unit (25) or third mixing unit (35).

18. Device (100) for carrying out a process according to claim 1, comprising a first mixing unit (15) and a metering tank (19) for metering or mixing of a base/alkaline solution (17) or a phosphate-fixing compound/liquid containing a phosphate-fixing compound (17) into the first mixing unit (15), which metering tank (19) is connected to the first mixing unit (15) in a fluid-conducting manner.

19. Device (100) according to claim 18, wherein the device (100) furthermore comprises a degassing unit (5) for degassing of the wastewater or sludge stream (2), which degassing unit (5) is upstream of the first mixing unit (15).

20. Device (100) according to claim 18, wherein the device (100) furthermore comprises a second mixing unit (25) downstream of the first mixing unit (15).

21. Device (100) according to claim 20, wherein the device (100) furthermore comprises a metering tank (29) for metering or mixing of a phosphate-fixing compound/liquid containing a phosphate-fixing compound (27) into the second mixing unit (25), which metering tank (29) is connected to the second mixing unit (25) in a fluid-conducting manner.

22. Device (100) according to claim 20, wherein the device (100) furthermore comprises a third mixing unit (35) downstream of the second mixing unit (25).

23. Device (100) according to claim 20, wherein the device (100) does not comprise a metering tank, connected to the second mixing unit (25) or third mixing unit (35) in a fluid-conducting manner, for metering or mixing of a base/alkaline solution or a phosphate-fixing compound/liquid containing a phosphate-fixing compound into the second mixing unit or third mixing unit.

24. Process according to claim 3, wherein the sparingly soluble phosphate is magnesium ammonium phosphate.

25. Process according to claim 7, wherein the coating prevents deposition of sparingly soluble phosphate in the mixing chamber (33) of the first mixing unit (15).

26. Process according to claim 8, wherein the base/alkaline solution (17) or the phosphate-fixing compound/liquid containing a phosphate-fixing compound (17) is metered or mixed into the mixing chamber (33) of the first mixing unit (15).

27. Process according to claim 26, wherein the annular gap (37) or the number of annularly arranged openings is arranged coaxially in relation to the opening (32) of a diaphragm (31) of the first mixing unit (15).

28. Process according to claim 9, wherein the pH in the mixing chamber (33) of the first mixing unit (15) is increased to from 7.2 to 11 as a result of the base/alkaline solution (17) being metered in or mixed in.

29. Process according to claim 11, wherein the magnesium or calcium salt is magnesium chloride and/or magnesium oxide and/or calcium chloride and/or the calcium silicate is calcium silicate hydrate.

30. Process according to claim 15, wherein the base/alkaline solution (17) is metered or mixed into the mixing chamber (33) of the first mixing unit (25) and the phosphate-fixing compound/liquid containing a phosphate-fixing compound (27) is metered or mixed into the mixing chamber (33′) of the second mixing unit (25).

31. Process according to claim 16, wherein the wastewater or sludge stream (2) is conveyed through a mixing chamber (33″) of the third mixing unit (35) via an opening of a diaphragm (31″) of the third mixing unit (35).

32. Device (100) according to claim 20, wherein the second mixing unit (25) has a diaphragm (31′) and a mixing chamber (33′).

33. Device (100) according to claim 22, wherein the third mixing unit (35) has a diaphragm (31″) and a mixing chamber (33″).
